(19) United States
(12) Patent Application Publication
(10) Pub. No.: US 2007/0254604 A1
(43) Pub. Date: Nov. 1, 2007

(54) Sound Communication Network

(76) Inventor: Joon Sik KIM, Daejeon (KR)

Correspondence Address: SUGHRUE MION, PLLC, 2100 PENNSYLVANIA AVENUE, N.W., SUITE 800, WASHINGTON, DC, 20037, US

(21) Appl. No.: 11/742,803

(22) Filed: May 1, 2007

(30) Foreign Application Priority Data
May 1, 2006 (KR) 10-2006-0039335

(51) Int. Cl. H04B 1/40

(52) U.S. Cl. 455/88

(57) ABSTRACT

A local area communication network in a distance of several to several tens of meters is disclosed. The local area communication network includes a personal area network (PAN) coordinator capable of performing sound and electric communications and controlling communication flow in the network, and at least one end device connected to the PAN coordinator through a sound and/or electric communication channel. The PAN coordinator includes a conversion means for performing mutual conversion between a sound communication protocol and an electric communication protocol, and can be connected to another external communication network.

### CROSS-REFERENCE TO RELATED APPLICATIONS

This application claims the benefit under 35 U.S.C. §119 of Korean Patent Application No. 10-2006-0039335, filed at May 1, 2006, in the Korean Intellectual Property Office, the entire disclosure of which is incorporated herein by reference.

### BACKGROUND OF THE INVENTION

1. Field of the Invention

The present invention relates to a method of constructing a network using local area sound communications, which can be applied to a ubiquitous sensor network (USN), a ubiquitous sensor and actuator network (USAN), a home network, a personal area network (PAN), and so forth.

2. Description of the Related Art

The ubiquitous sensor network (USN) is an integrated sensor network that manages information by measuring environmental information (such as position, image, sound, temperature, humidity, gas, pollution, and so forth) using chips attached to necessary objects and providing such environmental information through a network. The USN constructs information network that autonomously measures and controls a surrounding environment, and serves to perform object-to-person connections or person-to-person connections. The USN has been used in various fields such as production, distribution, medical treatment, health, welfare, calamity prevention, crime prevention, environment management, intelligent home service, telemetrics, military affairs, and so forth.

PAN is defined as local area network within several tens of meters, or a short-distance personal area network within several tens of meters around a user's portable terminal or wearable terminal. The PAN can be used in various fields. In the case of health management or first-aid medical treatment, for example, various kinds of biosensors that a user is wearing sense important bio-signals such as user's blood pressure, pulsation, body fat, exercise volume, sleeping state, paralysis, and fainting, and such bio-signals are transferred to a wide area medical center through a wide area communications using the PAN, so that the user can normally undergo his/her health care. If the bio-signal represents emergency, an alarm signal is generated to transfer the emergent situation to the user, family, medical institution, emergency center, and so forth.

The PAN itself is a useful network, and by connecting several PANs or combining the PAN with a wide area communication network, a massive network such as USN, USAN, home network, building network, and so forth, can be constructed. That is, the PAN may be the core constituent element of the USN, USAN, home network or building network. In the following description of the present invention, the local area network is commonly called a PAN. Also, a wireless personal area network (WPAN) has been standardized in IEEE 802.15. The famous Bluetooth and ZigBee technologies are related to the WPAN.

In order to popularize a PAN and a network and service using the PAN, various kinds of node devices and node devices capable of performing local area communications should be widely spread. At present, the spread of node devices is slight, and the spread of PAN is also slight since node devices have different local area communication way. In order to widely construct the PAN in any place, an enormous expense and time should be consumed.

Currently, with the development of communication networks including mobile communication network, portable terminals such as portable phones, PDAs, smart phones, and so forth, have been widely spread as personal necessaries. In the PAN, user's portable terminal can serve as a core node device. That is, user's portable terminal constitutes a PAN along with devices around the user, and serves as a PAN coordinator/router or a core node capable of playing a role of a user interface when it is connected to another network. However, most portable terminals being currently spread do not have local area communication function. Even if the portable terminal has the local area communication function, it is difficult for the portable terminal to become the node of the PAN since the each terminals use different communication systems such as IR, Bluetooth, ZigBee, and so forth.

In order to popularize the PAN, a new local area communication system is required, which can be used by almost all portable terminals being currently commercialized, without the necessity of replacing the portable terminal or adding any separate transmission device. It is also required that the local area communication system is implemented easily even in other existing node devices of the PAN at low cost and with low power consumption. In addition, a PAN node device is required, which has a simple interface between widely spread portable terminals and a person.

### SUMMARY OF THE INVENTION

Accordingly, the present invention has been made to solve the above-mentioned problems occurring in the related art, and an object of the present invention is to provide a method and system for constructing a local area communication network, which can construct a PAN of an area surrounding a user by using a portable terminal already owned by the user, without the necessity of replacing the portable terminal or purchasing a local area communication device linked to the portable terminal.

Another object of the present invention is to provide a method and system for constructing a local area communication network, in which node devices of a PAN can simply perform local area communications with other node devices of the PAN or user portable terminals.

Still another object of the present invention is to provide a method and system for constructing a local area communication network, in which node devices of a PAN can simply perform local area communications with other node devices of the PAN or user portable terminals.

Still another object of the present invention is to provide a method and system for constructing a local area communication network, which can perform communications as an alternative means when telecommunication interference, obstacle, or trouble occurs.

Still another object of the present invention is to provide a method and system for constructing a local area communication network, in which a PAN node device having two or more local area communication means can communicate with other different local area communication means in accordance with a required transmission speed or power consumption.

Still another object of the present invention is to provide a method and system for implementing a PAN node device having a convenient human interface.

Still another object of the present invention is to provide a method and system for constructing a local area communication network, which can strongly cope with the surrounding environment and stably perform the communications.

Still another object of the present invention is to provide a method and system for constructing a local area communication network having an interference prevention and security function for ensuring the reliability of signal transmission.

Yet still another object of the present invention is to provide a method and system for constructing a low-power local area communication network, which can minimize the power consumption of PAN node devices.

In order to accomplish these objects, according to one aspect of the present invention, there is provided a local area communication network, which includes a personal area network (PAN) coordinator capable of performing sound and electric communications and controlling communication flow in the network; and at least one end device connected to the PAN coordinator through a sound and/or electric communication channel; wherein the PAN coordinator includes a conversion means for performing mutual conversion between a sound communication protocol and an electric communication protocol, and can be connected to another external communication network.

Considering that a general portable terminal is basically provided with a microphone, a speaker, and an audio processing unit for processing voice call and bell sound, the present invention provides a method and system for constructing a PAN network surrounding a user through local area sound communications between the portable terminal and another node device by using a microphone and a speaker of the portable terminal that can be used as a core node device. The sound communication system according to the present invention transmits sound that carries information using a sound output means such as a speaker, and receives sound using a sound receiving means such as a microphone. Further, the present invention provides a method and system in which PAN node devices compatibly and efficiently construct a local area communication network with other PAN node devices or user portable terminals using sound communications.

The local area sound communications according to the present invention do not require the purchase of any additional transmission module or transmission device, do not affect the performance of the portable terminal owned by a user, and thus can be applied to almost all portable terminals through downloading of the related software only.

Generally, the sound communications are restricted in a very narrow area at a low speed and with a small capacity, and do not correspond to general communication requirements heading toward high-speed, large-capacity, and wide-range communications. Accordingly, the sound communications have been out of public interest and have not been in practical use, in comparison to the electric communications in which wide range communications become possible.

However, according to the present invention, a PAN network is constructed by actively using the sound communications, without being limited to temporary and fragmentary data communications, and thus tasks are executed by continuously and automatically performing data communications in the PAN network. Further, by connecting the sound communication PAN with the other existing network, global data communications and task executions can be achieved.

In the present invention, a node device means a device performs data communications disposed at each node of the network. The node devices are classified into a sound communication device (SCD), an electric communication device (ECD), and an electric and sound communication device (ESCD). The device may be a portable terminal, a sensor, or a actuator. However, the device is not limited thereto, and includes all electronic devices or apparatuses that require data transmission/reception in a relatively short distance.

In the present invention, the electric communications mean the transmission, emission, and reception of all kinds of symbols, signals, documents, images, sound or information according to wire, wireless, optical, or electromagnetic systems, in the same manner as the definition of International Telecommunication Convention. The electric communications include wire communications connecting two transmission/reception points by current lines and wireless communications using electromagnetic waves.

Also, in the present invention, node devices of the network that constitute the PAN are classified into a PAN coordinator, a PAN router, and an end device in accordance with their roles. On the network, the PAN coordinator serves as a master node, and the end device serves as a slave node. In the case where PAN routers and end devices exist on the network, the PAN router serves to relay data between the PAN coordinator and the end device, and the PAN coordinator controls the PAN router to hierarchically construct one PAN.

It is preferable that the PAN coordinator is implemented by an ESCD that can perform both sound communications and electric communications. The end device may be an ESCD, SCD, or ECD, and may be a device that can perform bidirectional communications or unidirectional communications corresponding to either transmission or reception only.

### BRIEF DESCRIPTION OF THE DRAWINGS

The above aspects and features of embodiments of the present invention will become more apparent by describing certain exemplary embodiments of the present invention with reference to the accompanying drawings, in which:

FIG. 1 is a view illustrating the constitution of a local area sound communication network according to the present invention;

FIG. 2A is a block diagram illustrating the constitution of a sound communication device (SCD);

FIG. 2B is a block diagram illustrating the constitution of an electromagnetic and sound communication device (ESCD);

FIGS. 3A and 3B are flowcharts illustrating data encoding and decoding method according to loaded coding rules;

FIGS. 4A to 4C are views illustrating an example of a mapping table in which the characteristic values of sound that are varied corresponding to digital data are a sound frequency, an amplitude, and a phase;

FIG. 5 is a view illustrating an example of a mapping table;

FIG. 6 is a view explaining four factors that affect the coding rules and the determination of a sound communication level;

FIG. 7 is a flowchart illustrating a process of connecting a sound communication local area network between node devices;

FIGS. 8A to 8C are views illustrating an example of a sound communication level selection menu for manual selection;

FIG. 9 is a view explaining a method of applying a mapping;

FIG. 10 is a view illustrating an example of a local area sound communication data packet frame format;

FIG. 11 is a timing diagram explaining a transmission/reception time synchronization for a low-power consumption;

FIGS. 12A and 12B are views illustrating the constitution of a local area sound communication network and a combined sound/electric communication network according to the present invention;

FIG. 13 is a view illustrating a protocol conversion function of an ESCD node device in a local area sound communication network according to the present invention;

FIG. 14 is a flowchart illustrating an indirect relay protocol conversion of an ESCD node device in a local area sound communication network;

FIG. 15A is a flowchart illustrating a direct relay protocol conversion from electric communications to sound communications for an ESCD node device in a local area sound communication network;

FIG. 15B is a flowchart illustrating a direct relay protocol conversion from sound communications to electric communications for an ESCD node device in a local area sound communication network;

FIG. 16 is a view illustrating the construction of a double-path (i.e., sound/electric) communication network according to the present invention;

FIG. 17 is a flowchart illustrating an automatic selection of local area communications in a double-path (i.e., sound/electric) communication network node;

FIG. 18 is a view illustrating the constitution of a human-sound interface of a sound communication node device according to the present invention; and

FIGS. 19A and 19B are flowcharts illustrating human-sound interface function of a sound communication node device during transmission and reception.

### DETAILED DESCRIPTION OF EXEMPLARY EMBODIMENTS

Exemplary embodiments of the present invention will now be described in detail with reference to the annexed drawings. In the drawings, the same elements are denoted by the same reference numerals throughout the drawings. In the following description, detailed descriptions of known functions and configurations incorporated herein have been omitted for conciseness and clarity.

FIG. 1 is a view illustrating the constitution of a local area sound communication network.

FIG. 1 shows a star topology type local area sound communication network. A PAN coordinator 101 may be an SCD or ESCD, and end devices 102 to 106 may be an SCD. In the drawing, dotted lines indicate sound communication paths. In addition to the star topology type, the local area sound communication network can be constructed in diverse types such as a cluster tree topology type, a mesh topology type, and so forth. Each node device can be connected to an external network to perform communications. In many cases, the PAN coordinator is connected to the external network. In one embodiment of the present invention, the PAN coordinator is implemented by an ESCD for an efficient connection of the PAN to the external network. In one embodiment of the present invention, the end device may be a device that can either transmit or receive sound only during the sound communication.

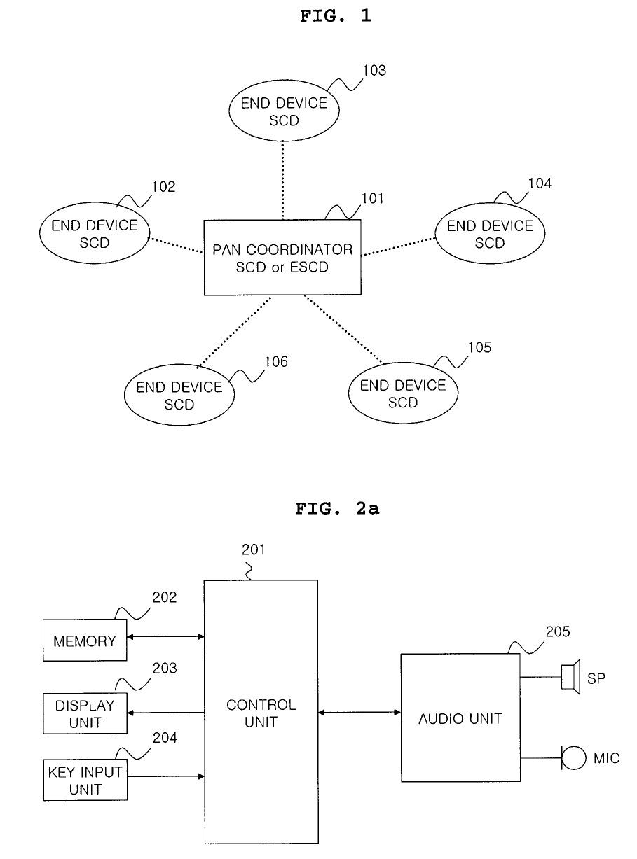

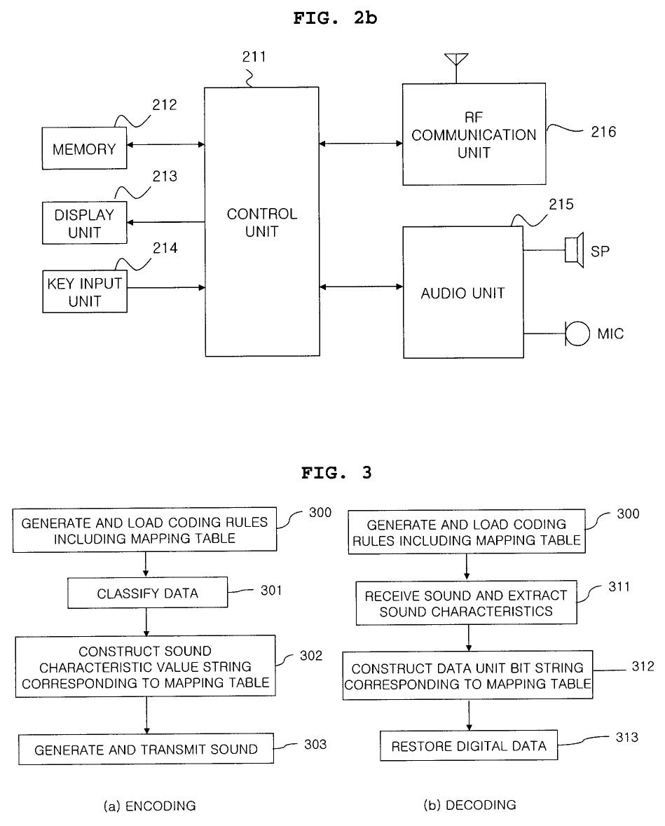

FIG. 2A is a block diagram illustrating the constitution of a sound communication device (SCD) that is a kind of node device in a local area sound communication network, and FIG. 2B is a block diagram illustrating the constitution of an electromagnetic and sound communication device (ESCD) that is a kind of node in a local area sound communication network.

An audio unit 205 of FIG. 2A or an audio unit 215 of FIG. 2B, in which a sound output means such as a speaker and a sound sensing means such as a microphone are provided, performs a function for sound communications according to the present invention. Since the sound communications according to the present invention become possible through a speaker and a microphone, even a hardware construction of a portable terminal such as an existing portable phone can adopt the sound communications.

An RF communication unit 216 of the ESCD may be a wide area wireless communication unit using a typical mobile communication network, or may be a local area wireless communication unit such as ZigBee or Bluetooth. In another embodiment of the present invention, the ESCD includes a wire electric communication unit instead of the RF communication unit 216.

In one embodiment of the present invention, the end device may be a device that can either transmit or receive sound only during the sound communication. In this case, The SCD or ESCD may be provided with only the sound output means such as a speaker or the sound sensing means such as a microphone.

FIGS. 3A and 3B are flowcharts illustrating data encoding and decoding processes according to coding rules loaded through the sound communication method according to the present invention.

The coding rules mean a series of rules for converting the original digital data into sound, encoding and transmitting the sound, and then decoding the received sound to restore to the original digital data. The coding rules include mapping table generation information and mapping table alteration information, unit time for outputting sound, data frame structure information, volume level, microphone sensitivity, and so forth. The mapping table is generated using the mapping table generation information and matches the digital data to sound. In the mapping table, if the characteristic values of sound to correspond to the digital data are the sound frequency, phase, or amplitude, they may be modulated by FSK, PSK or ASK data modulations, respectively. If the characteristic value is a combination of the frequency, phase, and amplitude, it can be combined by QAM (Quadrature Amplitude Modulation). In addition, the coding rules include time synchronization for synchronizing the data transmission/reception time between node devices, same sound continuance avoidance rules for preventing continuous transmission of the sound with the same level, encryption rules, and so forth.

FIG. 3A refers to the encoding process and FIG. 3B refers to the decoding process according to the coding rules. According to the sound communication system of the present invention, it is required that diverse kinds of node devices construct the network immediately in diverse surrounding environments with robustness and security. Accordingly, at step 300 of generating and loading the coding rules, one or more mapping tables in which the respective characteristic values of the sound correspond to the digital data in accordance with specified mapping table generation and alteration information, are generated and loaded. The mapping table generation information defines what modulation method (FSK, PSK, ASK, etc) is used, how many frequencies are used as the data frequency sound, what the insignificant frequency sound is, and so forth, and the alteration information includes information on how to or when vary the mapping table.

If the coding rules and the mapping table are generated and loaded at step 300, the data is encoded and transmitted through steps 301 to 303, and then the transmitted data is received and decoded through steps 311 to 313. The encoding process according to the coding rules as illustrated in FIG. 3A includes dividing the digital data to be transmitted into predetermined number of bits of data unit (step 301), converting respective digital data unit bit strings into series of the characteristic values (e.g., frequency, amplitude, and phase) of the sound that correspond to the mapping table (step 302), and generating and transmitting synthesized sound having the respective sound characteristic values (step 303). The decoding process according to the coding rules as illustrated in FIG. 3B includes extracting the sound characteristic values from the received sound (step 311), constructing the extracted sound characteristic value in the digital data unit bit strings that correspond to the mapping table (step 312), and restoring the data unit bit strings to the digital data (step 313).

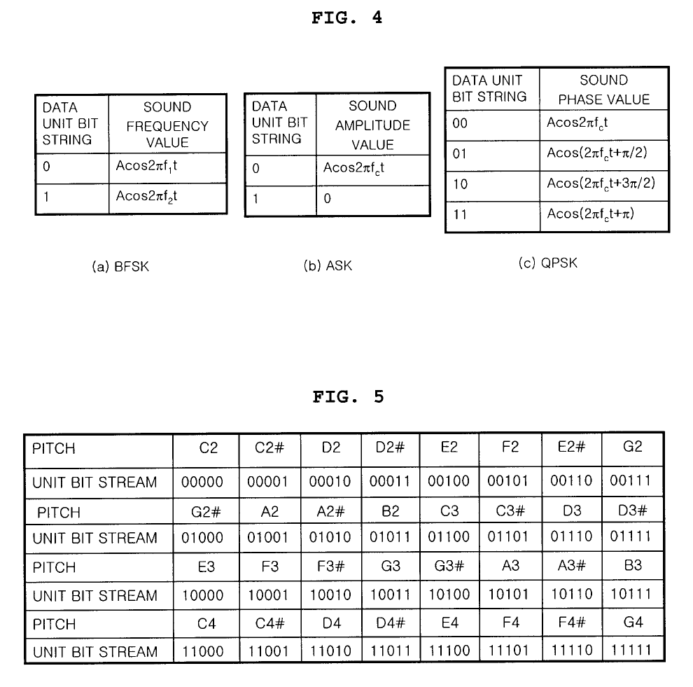

FIGS. 4A to 4C are views illustrating an example of a mapping table in which the characteristic values of sound corresponding to digital data are a sound frequency, an amplitude and a phase, respectively.

FIG. 4A shows an example of BFSK which is a kind of FSK modulation in which the characteristic value is the sound frequency. In FIG. 4A, the data unit bit strings “0” and “1” are converted to correspond to two frequencies “f1” and “f2” of the sound. FIG. 4B shows an example of the ASK modulation in which the characteristic value is the sound amplitude. FIG. 4C shows an example of QFSK which is a kind of PSK modulation in which the characteristic value is the sound phase. In FIG. 3C, the data unit bit strings “00”, “01”, “10”, and “11” are converted to correspond to the phases “0”, “π/2”, “3π/2”, and “π”, respectively.

FIG. 5 is a view illustrating an example of a mapping table in which the characteristic values of sound that are varied corresponding to digital data are MFSK (M-ary Frequency Shift Keying) modulation frequencies. Preferably, frequencies of sound used for communication can be same frequencies used in music. This frequency band width is felt comfortable or well acquainted. The respective intervals (frequencies) of the sound are mapped on the digital data units according to a mapping table, and thus the digital data transmission can be performed using the sound.

However, in the case where a node device attempts the sound communications according to the present invention in diverse real-world environments, a communication error due to the disturbance caused by surrounding noises may occur. According to the present invention, a method for securing proper sound communications in the coding rules is additionally provided.

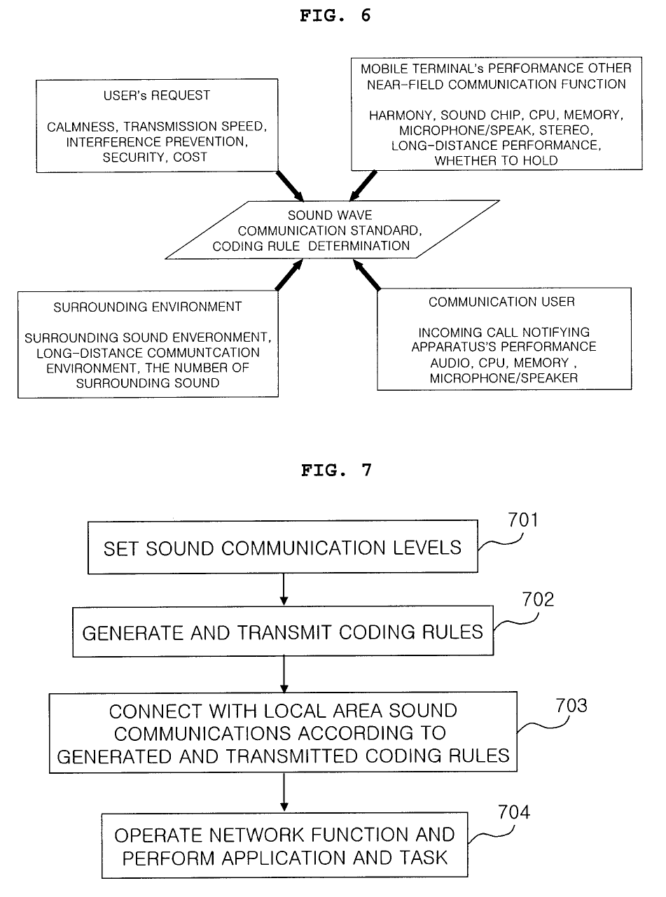

FIG. 6 is a view explaining four factors that affect the coding rules and the determination of a sound communication level.

As illustrated in FIG. 6, the four factors are user's and application's requirements, a surrounding environment, the performance of the node device itself, and the performance of the opposite node device. In consideration of all the four factors, proper coding rules well adapted for the situation can be determined, and thus an efficient sound communication network can be constructed.

Among the four factors, the user's and application's requirements include requirements of silence, sound comfort, low power consumption, interference prevention, security, data communication speed, low cost, and so forth. The silence requirement is greatly affected by the surrounding environment. If there is no person even in a quiet place, the degree of silence requirement becomes lowered, and in the case of noisy surroundings although there are many persons, the degree of silence requirement becomes lowered. The requirement of sound comfort is the requirement that can minimize the unpleasantness when a general person hears the sound of the sound communications. The requirements of interference prevention, security, and data communication speed depend on the characteristic of the related application program. Among the respective requirements, a trade-off relation exists. For example, the low power requirement is restricted by the requirements of interference prevention, security, and data communication speed.

Among the four factors, the surrounding environment includes the characteristic of a sound communication network in which the device will participate, surrounding sound environment, the number of nodes that use the surrounding sound communications, and so forth. Since a node device is used in diverse environments, it is important to consider the surrounding environment. Surrounding sound environments is more important in such case as the environments in which the surrounding sound is noisy, an ill-intentioned disturber generates disturbing sounds, or surroundings are extremely quiet. Meanwhile, as the number of nodes which participate sound communications becomes larger, sound interference becomes severer, and thus a special consideration thereof is required.

Among the four factors, the performance of the node device itself or the opposite node device includes sound output performance, sound source chip performance, sound frequency range of the node device, a stereo capability, processing/memory capability of the node device, possession of other local area communication function (e.g., wire, Bluetooth, ZigBee, and so forth), wide area communication capability, and so forth.

FIG. 7 is a flowchart illustrating a process of connecting a sound communication local area network between node devices according to the present invention.

In order to provide a sound communication system which can adapt itself to diverse types of the connected node devices and diverse surrounding environment, in the process of connecting a local area sound communication network between node devices, in one embodiment of the present invention, the coding rules and/or sound communication levels are transmitted.

The sound communication level is defined considering the transmission speed, sound volume, the number of chords, and so forth, and supports to generate a appropriate coding rule, so that the sound communication network can be compatibly and efficiently constructed in various environment.

In FIG. 7, step 701 is a step of determining the sound communication level, and step 702 is a step of generating a coding rule that corresponds to one or more node devices that participate in the communications and transmitting the coding rule to the opposite node device. Also, step 703 is a step of loading the transmitted coding rules for the respective node devices to connect to the sound communication network according to the coding rules. Alternatively, the step 701 may be omitted. In such case, one or more node devices that participate in the communications may generate and transmit one or more coding rules according to predetermined sound communication level. On the other hand, the PAN coordinator may determine the sound communication level, generates and transmits the coding rules to other node devices. The respective node devices connect to the sound communication network according to the transmitted coding rules.

A device, which intends to participate in the PAN after the network is set, requests participation in the PAN to the PAN coordinator, and receives an approval from the PAN coordinator. Then, the PAN coordinator transmits the coding rules to the device so that the device can decode the coding rules. The above-described request, approval, and transmission processes may be performed according to the sound communication rules agreed in advance or according to the user's device setting. Thereafter, the device performs data communications in the PAN network using the transmitted coding rules.

In another embodiment of the present invention, each node devices have the inherent coding rule for each sound communication level in advance, and in connection stage node devices determine the sound communication level, and thus the node devices that participate in the communications can generate or select coding rules individually according to the determined sound communication level. In this case, it is not required to transmit the coding rules, and thus it is easy to set the network. However, it is weak in security, and thus it is preferable to use it in a situation that the security is not important (e.g., various kinds of sensors) More specifically, at step 701 of determining the sound communication level, the sound communication level that is suitable for the present application is determined in consideration of the four factors. In one embodiment of the present invention, the PAN router or the PAN coordinator determines the sound communication level, and send this to the other node devices that serve as slaves. In another embodiment of the present invention, the sound communication level is determined though recommendation, negotiation, and confirmation processes.

In the recommendation process, the node device recommends the other node devices with one or more sound communication levels. Then, the sound communication level is confirmed by negotiating the recommended level. The negotiation may be replaced by a user's manual setting for the respective node devices. In the recommendation process, the user or the node device manually or automatically recommends singular or plural levels together with the priority in consideration of the user's and application's requirements, surrounding environment, and the performance of the node device itself.

In the negotiation process, an opposite node device selects a proper level among recommended sound communication levels in consideration of the four factors, and then determines the selected level through a negotiation. For example, if the performance of the opposite node device appropriate the third order, rather than first order and the second order, the sound communication level is determined as the level recommended by the third order. Alternatively, the respective node devices that participate in the communications recommend sound communication levels having the priorities, and then a proper level is determined through comparison and negotiation processes. The negotiation is performed by default sound communications, local area communications, or wide area communications between nodes, or is replaced by a user's direct input of the level to the node devices in accordance with the user's judgment.

For another example, two communicating node devices have different sound communication levels. When A and B node devices perform sound communications with each other, the communications from A to B may be set to a level g, and the communications from B to A may be set to a level h if the performances of the A and B node devices permits to do so.

If the sound communication level is set at step 701, the coding rules are generated and transmitted at step 702. If the communication is performed actually at one sound communication level, the operation starts from step 702. Even at one sound communication level, a plurality of coding rules that satisfy the level may exist.

For example, if it is assumed that the sound communication level is determined as a medium level, i.e., medium transmission speed level, medium interference prevention level, and low volume level, in consideration of the application characteristic, silence, sound comport, low power, and interference prevention, one or more coding rules corresponding to the level may be generated. One of possible mapping table types is determined, and the coding rules including generation and alteration information of the mapping table, sound unit time, data frame structure, and so forth, are determined. Also, if necessary, time sync information for synchronizing the data transmission/reception time, same sound continuance avoidance rules for preventing continuous transmission of the sound with the same level, encryption rules, and so forth, are determined to generate the coding rules.

In one embodiment of the present invention, in the case where the coding rules are generated in advance by sound communication levels as described above, the node devices do not generate and transmit the coding rules according to the sound communication levels. In another embodiment of the present invention, the generated coding rule by one node device can be transmitted to the other nodes.

In this case, the coding rules may be negotiated even at the coding rule transmission step. If the sound communication level is not defined or the communication is performed actually at one sound communication level, the negotiation of the transmitted coding rules can be performed, like the negotiation of the sound communication level at step 701.

Step 703 is a step at which the respective node devices load the generated or transmitted coding rule and mapping table, and connect to the sound communication network according to the rule. If the sound communications are connected, the network function is operated, and the application and tasks are performed (step 704).

From the foregoing, it is exemplified that the sound communications are first connected (steps 701 to 703), and then the application is executed (step 704). However, in another embodiment of the present invention, a specified application is first executed, and then the sound communications are connected to continue the execution of the application.

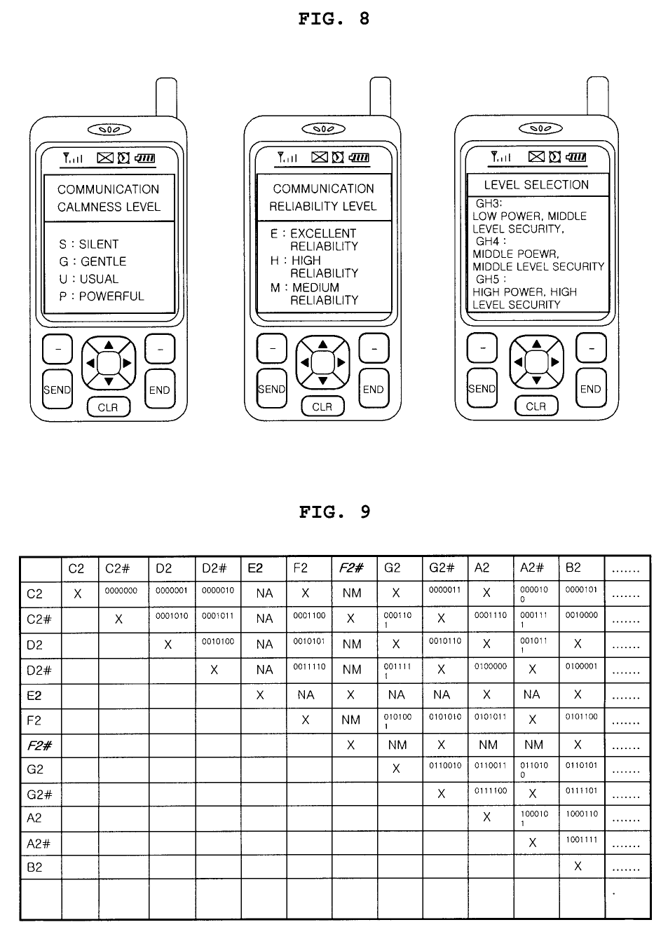

FIGS. 8A to 8C are views illustrating an example of a sound communication level menu construction for manual selection.

A selection menu for manually setting the sound communication level can be implemented in diverse forms. FIG. 8 shows an example in which the silence level of the communications and the data reliability level during the communications are considered. In this case, a user selects menu items by stages. The silence level is classified into “silence” (S), “gentle” (G), “usual” (U), and “powerful” (P), and the user selects one of them. The silent communications do not always mean that the volume is low. For example, frequency in an ultrasonic wave band is used for silent data transmission

If silence level is selected, a data reliability level selection menu is displayed. The data reliability, for example, is classified into “excellent” (E) that is an excellent reliability with relatively large power consumption, “high” (H) that is the high reliability with medium power consumption, and “medium” (M) that is medium reliability with relatively small power consumption.

If silence level and reliability level are selected, one or more candidate sound communication levels which the performance of the node device itself can cope with are displayed. As shown in FIG. 8, if (G) and (H) selected in above selection stage, candidate sound communication levels of GH3, GH4, and GH5 are displayed. If the user selects one of the displayed levels, the selected level is considered as the first order priority and recommended. Other levels can be also recommended with lower priority. Among one of more recommended levels appropriate sound communication level is confirmed through the negotiation.

In the negotiation process, for example, the opposite node device selects a proper level among the sound communication levels recommended by a node device in consideration of the four factors. If no proper level exists, the opposite node device report this to the node device so that the node device re-recommends other levels. Through the above-described process, the recommended level is negotiated and confirmed. As another example, all of the node devices that participate in the communications recommend the sound communication levels having the priorities, and one of the recommended levels is determined through comparison and negotiation processes. If no agreed level exists, the respective node devices re-recommend other levels. The negotiation is performed through default sound communications between nodes, local area communications, or wide area communications, or through the user's direct input of the level to the node device.

If the user does not manually set the sound communication level, it is automatically set. Even in the manual setting process, many parts are automatically set except for the user's selection process. The automatic setting is performed according to a predetermined priority. For example, the priority is set in the order of silence, power consumption, interference prevention, security, and communication speed.

FIG. 9 is a view explaining a method of applying a mapping rule including non-permitted frequency sound, and an insignificant frequency sound (it is exemplified that non-permitted frequency sound is denoted by E2, and the insignificant frequency sound is denoted by F2#).

(Data Frequency Sound, Non-Permitted Frequency Sound, and Insignificant Frequency Sound)

The sound communications require strength and security against surrounding noises or intentional interference sound. An intentional trespasser is classified into a disturber who generates a disturbing sound and a spy who overhears secretly and steals information. The data frequency sound or the permitted frequency sound defined in the present invention is for data to be transferred. The non-permitted frequency sound is a frequency excluded from the data transmission of the present coding rules, and the participating node does not generate the sound of this frequency. If the sound neighboring the non-permitted frequency is received, it means that noise has occurred or a trespasser exists. The insignificant frequency sound is a frequency excluded from the data transmission of the present coding rules, and the sound of this insignificant frequency sound is intentionally generated to confuse the spy. The mapping table includes the data frequency sound, the non-permitted frequency sound, and the insignificant frequency sound.

In FIG. 9, the data frequency sound, the non-permitted frequency sound, and the insignificant frequency sound are illustrated. It is assumed that E2 sound is the non-permitted frequency sound and F2# sound is the insignificant frequency sound, and the sound in the remaining part of the table is the data frequency sound. A mapping table between digital data and sound is constructed using combinations of two frequency sounds. In the table, X denotes a combination excluded due to overtones, NA denotes a combination that includes the non-permitted frequency sound, and NM denotes a combination that includes the insignificant frequency sound. The data is transmitted as the sound based on the mapping table, the insignificant frequency sound disturbs the spy, and the existence of the disturber is investigated by sensing the non-permitted frequency sound.

(Mapping Table Variation)

In one embodiment of the present invention, by varying the mapping table, a sound communication system that is robust against the interference is constructed. The mapping table variation includes variation of the data frequency sound, the non-permitted frequency sound, or the insignificant frequency sound, and the mapping table is varied according to the information written in the mapping table generation and alteration information. For example, in the case of using the BFSK, the mapping table is varied by varying the frequency sounds f1 and f2 with the lapse of time. The variation includes amplitude variation and phase variation in addition to the sound frequency variation. The variation may be performed when the application newly starts or with the lapse of time. If the mapping table is varied according to time or order, data is encoded or decoded with different mapping tables at a specified time or in a specified order. The disturber or the spy who cannot accurately know the mapping table at the specified time or in the specified order hardly to disturb or intercept the transmission data.

(Same Frequency Sound Avoidance)

In one embodiment of the present invention, in order to perform the transmission that is strong against the interference and to prevent the transmission error, a same frequency sound avoidance rule is included in the generation of the coding rule so as to prevent the successive reception of the same pitch over a specified time. For example, if it is required to send the same pitch sound over a predetermined time, the insignificant frequency sound is inserted into the same pitch sound.

(Volume Limitation)

In one embodiment of the present invention, in order not to disturb other neighboring sound communication groups, the volume of the sound transmitted from the respective participating node device is limited, and thus the respective participating node devices recognize and read the sound having a sound strength within an agreed volume range.

(Feedback Sensing)

In one embodiment of the present invention, a transmission node device checks whether any threatening noise or disturbing sound exists in a sound signal to be transmitted by receiving surrounding sound before transmitting the sound signal or receiving the transmitted sound signal as a feedback. If another node is communicating using the same frequency as that used by the node device or the noise of the frequency is severe as a result of checking, the node device waits for the transmission. In addition to such collision avoidance (CA), the sound communication, which corresponds to a low frequency communication, can perform collision detection (CD) effected by energy detection which is used in wire communication, but is hardly used in wireless communication. The node device judges the degree of the disturbing sound and/or interference sound by receiving the transmitted sound signal as a feedback, and determines whether to re-transmit the data according to the result of judgment. The transmission node device adjusts the volume of the transmitted sound by judging whether the volume of the sound through the speaker or microphone is proper. If there exists a threatening interference sound that cannot be solved through a volume adjustment, the node device varies the mapping table so that the sound neighboring the frequency sound of the interference sound is considered as the non-permitted or insignificant frequency sound. Accordingly, the node device performs the communications with the sound of the frequency region except for the noise/disturbing frequency.

(Interference Prevention using Human Ear)

Since the sound can be heard, unlike radio waves, persons surrounding the node can feel the existence of the noise and the interference sound with ear. For example, if a continuous interference sound exists, a person neighboring the node such as a user can correct the sound. On the other hand, information such as tone color, phonetic symbols, and so forth, which the node device cannot discriminate but human ear can discriminate from the frequency sound, may be included in the frequency sound to be transmitted. For example, if the frequency sound, into which the tone color and phonetic information such as “Ga”, “Ra”, and so forth have been included, is transmitted, the receiving node device recognizes only the frequency, but the human ear can recognize even the tone color and phonetic information. Accordingly, even if the same interference sound as the frequency sound is generated, persons around the node can recognize and cope with the interference due to the difference between the frequency sound and the tone color/phonetic information.

On the other hand, the sound communications are required to minimize the rejection feelings of the persons surrounding the node device. For example, a chord that persons like may be used when the mapping table is selected and the sound is transmitted. When the chord is attached to the frequency sound, lots of insignificant frequency sound, which is not the actual data, is used. Alternatively, a melody/chord that persons like to hear may be transmitted. As a white noise is generated, the sound communications may be performed, so that persons around the node device can hear the white noise that is not harsh to the ear. Alternatively, sounds around the node device may be sensed, and proper sound from which persons can feel pleasure or convenience is generated according to the sensed sounds. For a silent communication, natural sound such as water sound, sound of rain, and so forth, may be added to the frequency sound to be transmitted. Alternatively, sound communications may be performed by considering frequency sound in the band of ultrasonic waves or in the band neighboring the ultrasonic waves.

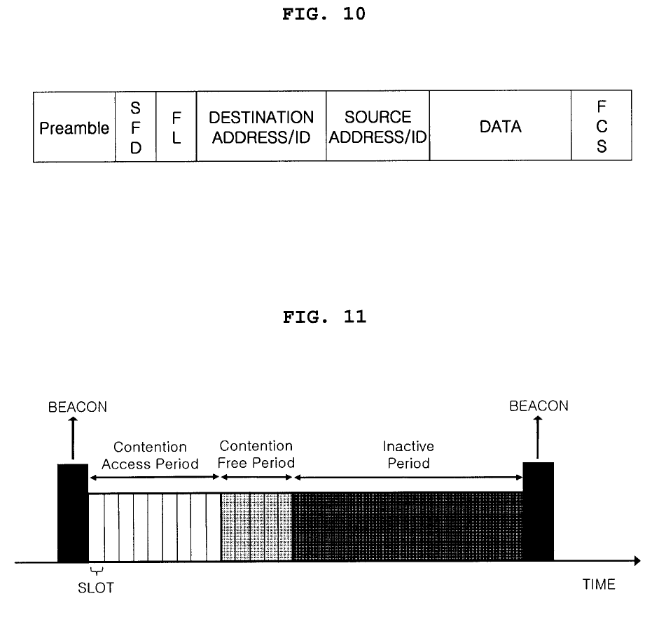

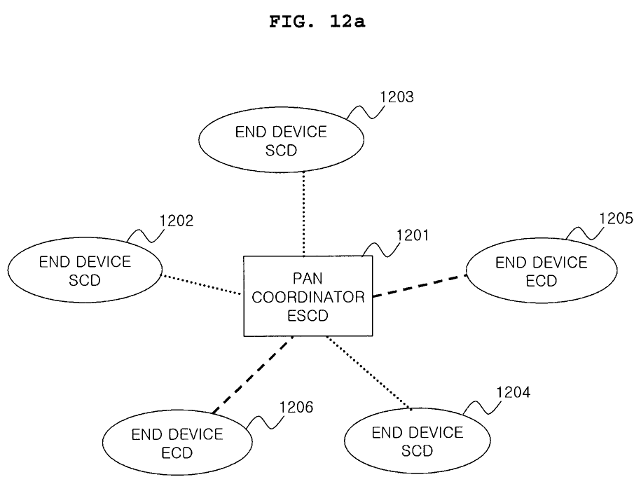

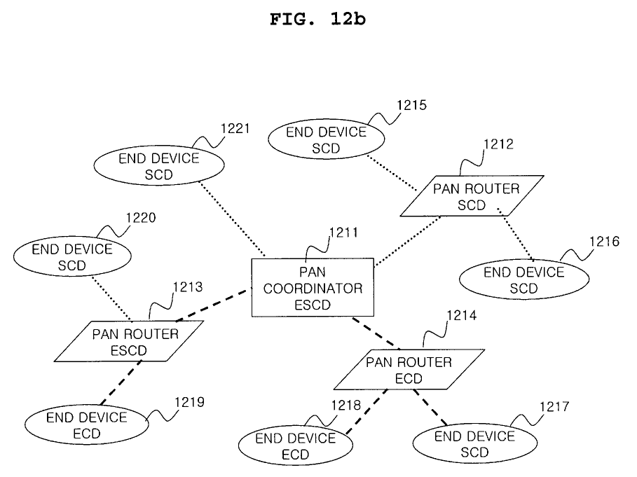

FIG. 10 is a view illustrating an example of a local area sound communication data packet frame format according to the present invention. The data packet frame format is composed of a preamble for synchronization, start of frame delimiter (SDF) indicating a frame start, frame length (FL), destination (i.e., destination node device) address or ID, source (i.e., source node device) address or ID, data, and frame check sequence (FCS) for checking transmission error. FIG. 10 is merely exemplary, and the data packet format is systematically constructed according to the protocol layer.

In another embodiment of the present invention, encrypted communications are performed to counteract against a disturber that disguises itself as a participating node and sends intentional interference signal. The encryption rule is a part of the coding rules. If the disturber, which disguises its own address as the address/ID of the normal participating node device, generates an interference signal, the participating node device having the above-described address/ID receives the interference signal, and informs the surrounding nodes of the fact that the interference signal is not originated from the participating node device itself.

FIG. 11 is a timing diagram explaining transmission/reception time synchronization for a low-power consumption.

Many node devices are provided with batteries as power supply means. If a node device continues the sound communications, a CPU installed therein bears a great burden, and the battery power consumption becomes great. Since a sound communication unit cannot know whether the opposite node device transmits the sound signal although the opposite node device stops the transmission of the sound signal, the corresponding node device continues reading and detection of the sound frequencies. This causes waste of resources and power of the node device.

In order to reduce the power consumption of the node device, in one embodiment of the present invention, a PAN coordinator or a PAN router, which serves as a master node, transmits/receives data to/from a slave node in a polling manner.

In order to reduce the power consumption of the node device, in one embodiment of the present invention, a method of synchronizing a transmission/reception time is provided. For the transmission/reception time synchronization, as shown in FIG. 11, a superframe structure using beacons is adopted. Network participating node devices that share the transmission/reception time synchronization rules performs communications as they follow the time management of the superframe structure of FIG. 11. The PAN coordinator or the PAN router, which serves as a master node, periodically transmits beacons, and slave nodes receives the beacons and participate in the network based on the received beacons.

In a contention access period (CAP) as shown in FIG. 11, the slave nodes competitively obtain authorities to communicate with the master node. In this case, a carrier sense multiple access—collision avoidance (CSMA-CA) algorithm may be used. The slave node device, in order to obtain the channel access authority from the master node, checks whether any other slave node uses a channel before it performs the transmission. If another node uses the channel, the slave node device waits for a specified backoff time, and then checks again whether another node users the channel. If another node does not use the channel as a result of checking, the slave node device attempts the transmission. The backoff time can be randomly selected, and thus the probability that a plurality of slave nodes come into collision during the transmission is reduced.

In a contention free period (CFP) as shown in FIG. 11, CFP time slots are allocated to the node devices in a manner that a communication authority time slot is allocated to only one node device at a specified time in the CFP. The node allocated with the time slot in the CFP is guaranteed a minimum transmission speed. In an inactive period as shown in FIG. 11, channel access is restricted with respect to all the devices in the PAN, and thus the respective nodes operate in an inactive mode in which the power consumption becomes very small, in comparison to the active period, to reduce the power consumption.

The transmission/reception time synchronization method is a part of the coding rules, and may be transmitted during the transmission of the coding rules.

FIGS. 12A and 12B are views illustrating the constitution of a local area sound communication network and a combined sound/electric communication network according to the present invention.

FIG. 12A shows an example of a star topology type combined sound communication and electric communication network, and FIG. 12B shows an example of a cluster tree topology type combined sound communication and electric communication network. In the drawings, PAN coordinators 1201 and 1211 comprise ESCD, and end devices comprise SCD or ECD. Dotted lines indicate the sound communications, and dashed lines indicate the electric communications. In addition, an electric communication includes a wire and a wireless communication.

In the network of FIG. 12A, the PAN coordinator 1201 performs sound communications with end devices 1202 to 1204, and performs electric communications with end devices 1205 and 1206 to form a network. The PAN coordinator serves as a single master or hub, and controls communication flow between other devices in the network.

In the network of FIG. 12B, the PAN coordinator 1211 comprises ESCD, end devices 1215 to 1221 comprise SCD or ECD, and three PAN routers 1212 to 1214 belonging to the PAN coordinator 1211 comprise SCD, ESCD, and ECD, respectively. The three PAN routers 1212 to 1214 are directly connected to end devices that belong to the respective PAN routers in the network, and are connected to the PAN coordinator 1211 to relay so that the end devices 1215 to 1221 form the network together with the PAN coordinator 1211.

In the networks as illustrated in FIGS. 12A and 12B, two or more different PAN networks (e.g., the sound communication and electric communication networks) share a personal area (PA) around a user. Since different PAN networks share one personal area, the two types of PAN networks can be managed as a single PAN network. In this case, the ESCD PAN coordinator 1201 serves as a protocol converter that can perform data communications between the SCD end device and the ECD end device.

In addition to the above-described topologies, diverse topology types such as mesh topology and so on can be adopted in constructing the combined local area sound communication and electric communication network. In many cases, the PAN coordinator is connected to an external network to form an additional network.

As described above, in the ESCD device in which both the electric communications and sound communications are possible, the electric communications includes wire communications and wireless communications. Specifically, a wire communication regions may be included in the PAN network, and the device can be connected to an external network though wire communications.

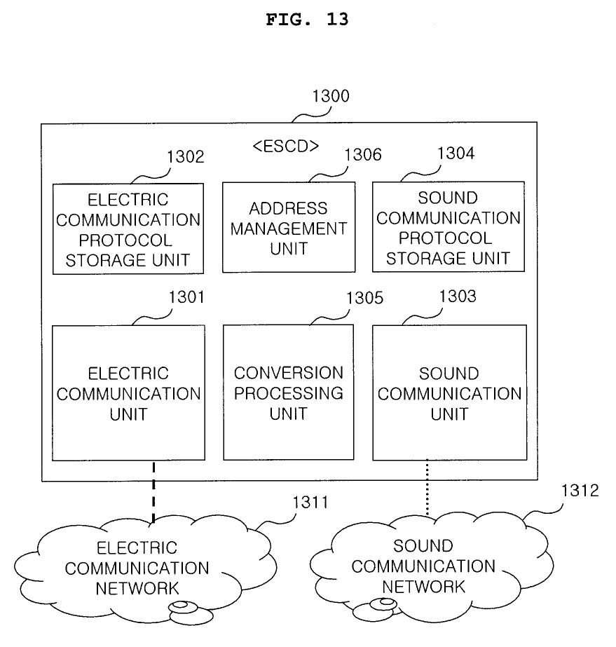

FIG. 13 is a view illustrating a protocol conversion function of an ESCD node device in a local area sound communication network according to the present invention.

Referring to FIG. 13, the ESCD node device of FIG. 2 is reconstructed, focusing on the protocol conversion function. The ESCD node device 1300 includes an electric communication unit 1301, an electric communication protocol storage unit 1302, a sound communication unit 1303, a sound communication protocol storage unit 1304, a conversion processing unit 1305, and an address management unit 1306.

The electric communication protocol storage unit 1302 and the sound communication protocol storage unit 1304 store electric communication protocol stacks and sound communication protocol stacks, respectively. The electric communication unit 1301 and the conversion processing unit 1305 communicate with an electric communication network 1311 to process data by executing the electric communication protocol in cooperation with each other. The sound communication unit 1303 and the conversion processing unit 1305 communicate with a sound communication network 1312 to process data by executing the sound communication protocol in cooperation with each other.

The address management unit 1306 stores and manages not only its own address but also addresses/IDs of other node devices connected thereto, shortcut addresses, routing tables, and so forth. The address management unit 1306 also stores protocols required during communications with a device connected thereto. In addition, the address management unit 1306 can store and manage status values of the devices connected thereto (e.g., in the case of a sensor, a measured value, measurement time, and so forth).

The shortcut address is a PAN internal address used for communications between nodes connected through a local area PAN network. The shortcut address is allocated by the PAN, used inside the PAN, and for example, allocated to the respective node by the PAN coordinator. For example, if it is assumed that a PAN coordinator of a specified PAN has a certain hexa address “ADF3920753648A01 as the device address, and two node devices A and B in the PAN have addresses “ADF3920752794523”, and “BAC1542732398A55”, respectively, the PAN coordinator allocates shortcut addresses “01” and “02” to nodes A and B, respectively. In the PAN internal communications, the shortcut address is preferentially used. For example, in the case where the PAN internal node devices communicate with each other, a field that indicates the internal communications is designated in a data packet, and only the shortcut addresses are used in a destination and source address field. If the shortcut addresses are used, the size of the address field of the packet is reduced, and thus the data communication efficiency of the sound communications that are low-speed communications is heightened.

The conversion processing unit 1305 decides whether the conversion process is needed, according to the destination address/ID or the source address/ID, and if necessary, it performs protocol conversion in cooperation with electric communication unit and the sound communication unit. In the case of performing the protocol conversion, since the data packet frame structure may differ according to the protocol, or a header, tail, or data size may differ, the conversion processing unit performs the data packet conversion to match them. For example, the data packet may be divided or combined.

In the case where the ESCD node device, which serves as the PAN coordinator or the PAN router, serves as a relay node, and the PAN internal or external network node, which is connected to the relay node through the electric communications, communicates with the relay node or the end device connected to the relay node through the sound communications, the relay node performs an indirect relay and a direct relay.

In the case of the indirect relay, in one embodiment of the present invention, the relay node periodically performs sound communications with the destination node, receives status values (e.g., in the case of a sensor, a measured value, measurement time, and so forth) of the destination node, and stores the received status values to manage the status values. If an external electric communication network connected to the relay node request the data such as the status values of the destination node and so on, the relay node extracts the corresponding data, and transmits the data to the network with the protocol of the electric communication network.

In the case of the indirect relay, in another embodiment of the present invention, the electric communication network connected to the relay node requests the data such as the destination status values stored in the relay node by using only the address of the relay node, and the relay node transmits the corresponding data to the network, so that the access to the data of the destination node is indirectly performed. In this case, the electric communication network may consider that one relay mode performs several functions. For example, when an SCD end device having a temperature sensor function is connected to the ESCD PAN router that is the relay node, the electric communication network accesses the relay node only with the address of the relay node, and inquires the temperature, so that the data transmission/reception is indirectly performed.

In the case of the direct relay according to the present invention, the relay node receives the data packet that the electric communication network connected to the relay node transmits to the destination node, and if necessary, the relay node transmits the data packet to the destination node or the next relay node through the protocol conversion.

The protocol conversion is performed by mutually conversion between respective fields including source address, destination address, and data fields in the data packet that follows a specified electric communication protocol, and respective fields including source address, destination address, and data fields in the data packet that follows the sound communication protocol.

A data packet generally includes a destination address/ID. However, the data packet may include only a source address/ID, instead of the destination address/ID, in relation to a specified application. Since even in the case of no destination address, a similar process can be performed, it is exemplified that the destination address exists in the data packet in the embodiment of the present invention.

If the destination address corresponds to the relay node itself when a data packet is received from the electric communication network connected to the relay node, the relay node itself processes the data packet, and transfers the data packet to a upper protocol layer, so that the data packet can be processed in the related application.

If the destination address does not correspond to the relay node itself, the relay node decides whether the destination address should be relayed with reference to the address management unit 1306. If it is judged that the destination address should be relayed, the relay node transmits the data packet to the next address. If the protocol related to the next node address is different from that in the previous address, the protocol conversion is performed.

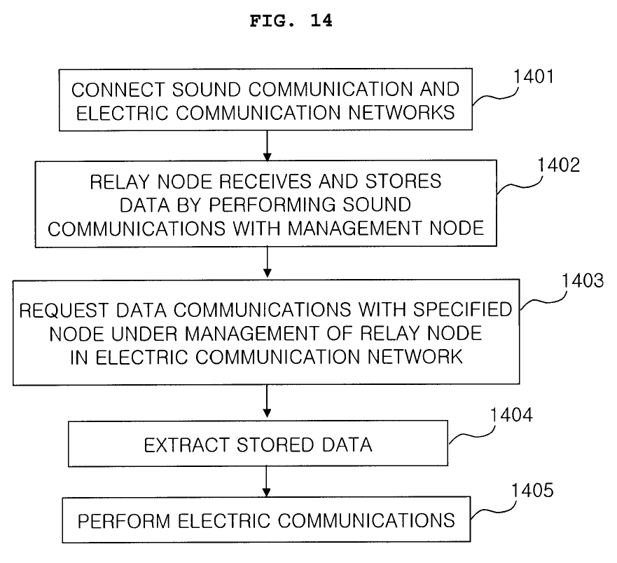

FIG. 14 is a flowchart illustrating an indirect relay protocol conversion of an ESCD node device in a local area sound communication network.

Referring to FIG. 14, at step 1401, the relay node device connects to both of the sound communication and electric communication network related to the relay node. At step 1402, the relay node receives and stores data of the destination node that is managed by the relay node through sound communications. The relay node periodically communicates with the destination node, receives status values (e.g., in the case of a sensor, a measured value, measurement time, and so forth) of the destination node, and stores the received status values to manage the status values. Then, at step 1403, if a certain node of the electric communication network requests data communications with a specified destination node under the management of the relay node, the relay node extracts the corresponding data stored therein (step 1404), and transmits the extracted data to the node to match the protocol of the electric communication network (step 1405).

In the case of the above mentioned indirect relay, the relay node transmits and processes the corresponding data of the destination node that is stored in itself in place of the destination node, so that the access to the destination node data is indirectly performed.

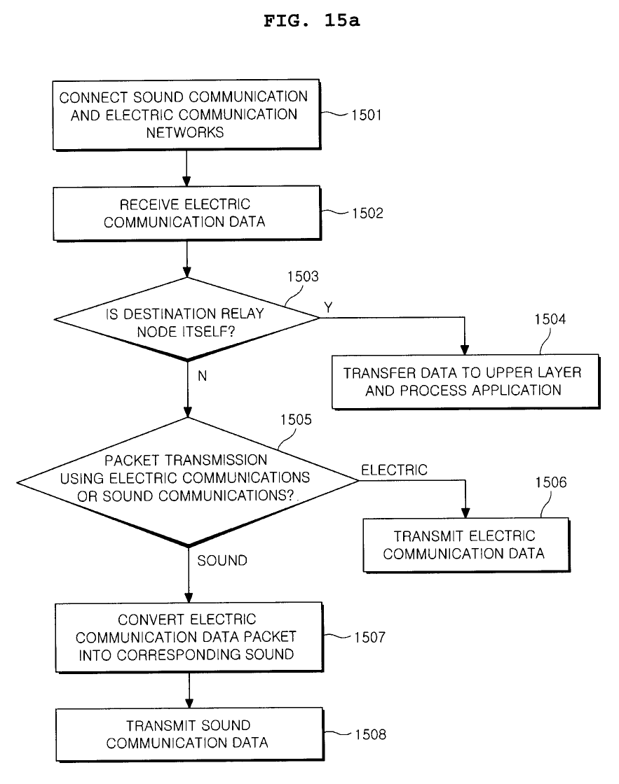

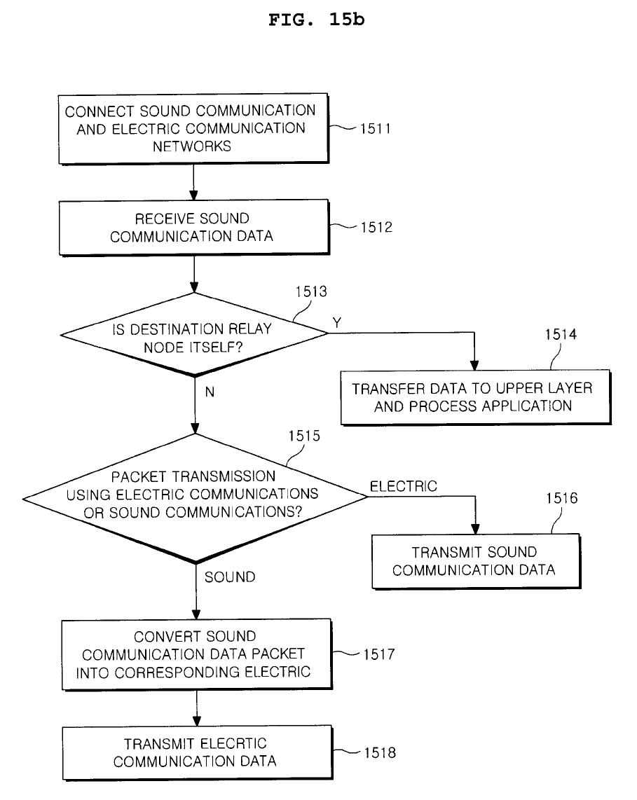

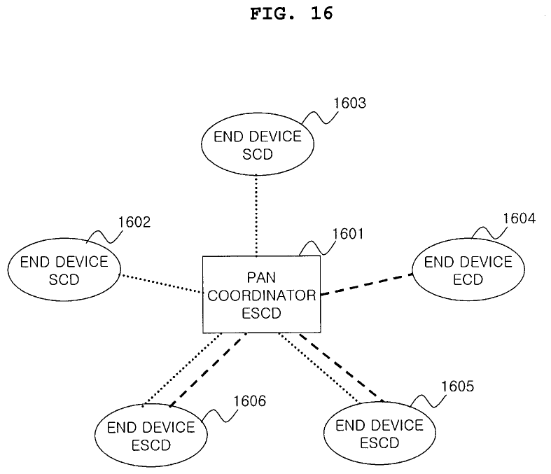

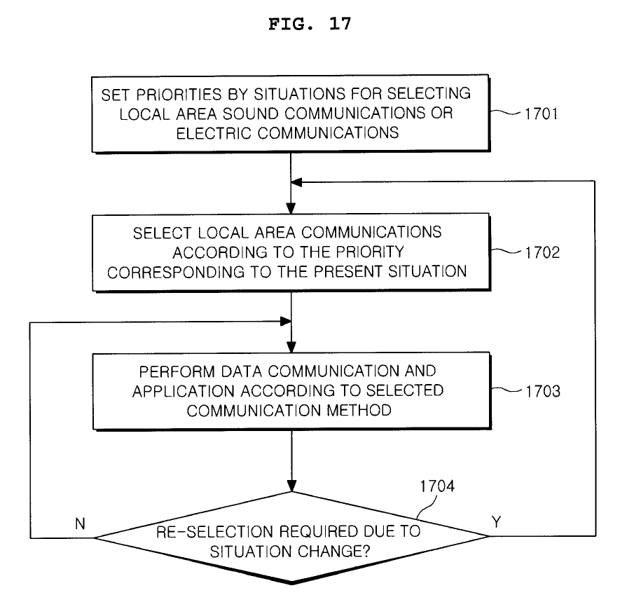

FIGS. 15A and 15B are flowcharts illustrating a direct relay protocol conversion of an ESCD node device in a local area sound communication network.

FIG. 15A shows a protocol conversion of electric communications into sound communications, and FIG. 15B shows a protocol conversion of sound communications into electric communications.

At step 1501 of FIG. 15A, the relay node device connects to the sound communication network and electric communication network. At step 1502, the relay node receives a data packet transmitted by a certain node of the electric communication network, and extracts the destination address from the received data packet by decoding the received data packet according to the protocol of the electric communications. Then, the relay node judges whether the extracted destination address is the address of the relay node itself (step 1503). If so, the relay node transfers the data packet to a upper protocol layer and decodes the data packet, so that the data packet is processed in the related application (step 1504). If the destination node is not the relay node itself, the relay node decides the next node (which may be a destination node or the next relay node) to which the relay node will transmit the data packet to send the data packet to the destination, with reference to the address management unit 1306. Then, the relay node decides the type of communication (step 1505). If the decided communication type is the electric communication, the relay packet transmits the data packet using the corresponding electric communication protocol (step 1506). If the decided communication type is sound communication, the relay node converts the electric communication data packet into the corresponding sound communication data packet through the protocol conversion (step 1507). In the case of performing the protocol conversion, since the data packet structure may differ according to the protocol, or a header, tail, or data size may differ, the data packet is converted to match them. For example, since the speed of the sound communications is lower than that of the electric communications, the data packet may be divided or combined. At step 1508, the protocol-converted data packet is transmitted to the next node through the sound communications.

The protocol conversion of the sound communications into the electric communications as shown in FIG. 15B is opposite to the protocol conversion of the electric communications into the sound communications, and thus the same process as that as shown in FIG. 15A is performed.

In the protocol conversion process, as described above, the PAN coordinator/router may use a shortcut address to designate a next node.

In another embodiment of the present invention, the shortcut address is used to designate a device in an external network in addition to a network internal device.

Specifically, the PAN internal shortcut address is allocated not only to the PAN internal node but also to the node in the external network, and is recorded in an address correspondence table in each node. The address correspondence table is a table in which public addresses such as IP addresses and MAC addresses correspond to the PAN internal shortcut addresses. The address correspondence table is managed by the address management unit. In the address correspondence table, internal nodes and external nodes are separately indicated. In the case where the PAN internal node transmits a data packet to the external network node to which the shortcut address has been allocated, the shortcut address of the external nod is put in the destination address of the packet. Accordingly, the size of the packet to be transmitted in the sound communication network is reduced.

If the packet is transmitted from the external network node to the PAN internal node, the PAN coordinator allocates the shortcut address to the external node, and in the case where the internal node communicates with the external node, the internal node transmits the packet using the shortcut address. In the protocol conversion process, the PAN coordinator converts the shortcut address into the public address, and sends the converted address to the external node.

If the destination external node exists in the address correspondence table when the PAN internal node intends to transmit the packet to the external node, it uses the shortcut address. If the destination external node does not exist in the table, the PAN internal node inquires the PAN coordinator of the public address of the external node, and the PAN coordinator finds out the external node, allocates the shortcut address to the external node, and informs the internal node of this.

The shortcut address includes an internal shortcut address for designating a node in the network and an external shortcut address for designating a node in the external network.

As described above, not only the PAN coordinator but also the PAN router can manages the address correspondence table.

FIG. 16 is a view illustrating the construction of a dual path (i.e., sound/electric) communication network according to the present invention.

FIG. 16 shows an example of a communication network formed by dual path between an ESCD PAN coordinator 1601 and an ESCD end devices 1605 and 1606 in a star topology type combined sound communication and electric communication network.

In the dual path communication network, a communication network is formed by dual path between the ESCD node devices in the PAN. The ESCD nod that performs dual path communications properly selects the communication type between the sound communications and the electric communications according to the application's requirement, surrounding environment, and node device performance. The requirements such as communication speed, communication quality, power consumption, and so forth are changed according to situations. When the requirements are changed, the dual path communication node selects either the sound communications or the electric communications. For example, if an amount of data that the application should communicate with the opposite node is small in the case of using Bluetooth as the electric communication means, the dual path communication node selects low-power sound communications. If the high speed communication is required as the amount of data to be transmitted becomes large, the dual path communication node selects the Bluetooth electric communications.

In addition, the dual path communication node according to the present invention is provided with a function of reporting the obstacle or trouble of the electric communication unit through the sound communications, and a function of reporting the obstacle or trouble of the sound communication unit through the electric communications. Accordingly, the trouble diagnosis and maintenance/repair of the communication node device can be performed at low cost and with high efficiency.

In addition, the dual path communication node according to the present invention has a function of performing the sound communications as emergency communications when the interference, obstacle or trouble of the electric communications occurs. In the same manner, the dual path communication node has a function of performing the electric communications as emergency communications when the interference, obstacle or trouble of the electric communication s occurs.

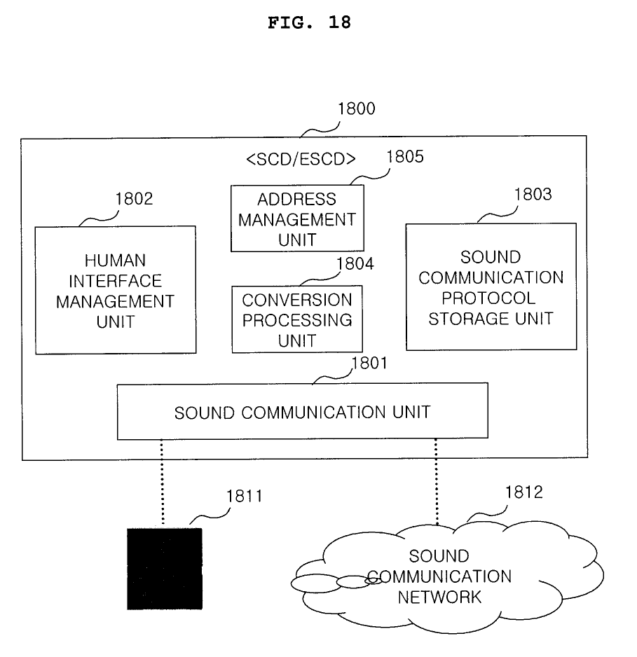

FIG. 17 is a flowchart illustrating an automatic selection of local area communications in a dual path communication network node according to the present invention.

Referring to FIG. 17, step 1701 is a step of setting in advance a prior communication type according to the situation of the local area sound communications and the electric communications before the connection of the local area communications. The priority is determined in consideration of the user's and application's requirements, surrounding environment, node device performance, and so forth.

At step 1702, the appropriate local area communication types are selected according to the priority corresponding to the present situation. For example, all the node devices present usable local area communication methods, perform negotiations according to the priority, and select the local communication type. The respective node devices directly present the usable communication type through any available communication way or through default sound communication way.

At step 1703, the data communications are performed according to the selected communication type, and an application is executed.

Step 1704 is a step of judging whether the reselection of the local area communication type due to the situation change is necessary. If change of communication type is required due to the situation change, the reselection is performed at step 1702. If data communications are performed in a newly selected communication type, the previously established communication channels are terminated, are in an inactive state, or are in a connection state but no data is transmitted/received.

FIG. 18 is a view illustrating the construction of a human interface of a sound communication node device according to the present invention.

The SCD or ESCD node device according to the present invention implements the node-to-node sound communication function and the node-to-person sound communication function using the same sound communication unit. Using the node-to-person sound communication function, the node device recognizes human voice and sound, and reports to a person through voice and sound.

FIG. 18 shows a reconstructed system of an SCD or ESCD node device, focusing on the node-to-person sound communication function. The SCD or ESCD node device 1800 includes a sound communication unit 1801, a human interface management unit 1802, a sound communication protocol storage unit 1803, a conversion processing unit 1804, and an address management unit 1805.

The sound communication unit 1801 includes a sound output means such as a speaker and a sound sensing means such as a microphone. The sound communication unit transmits sound that a person can recognize, or receives human voice by executing not only a node-to-node sound communications but also node-to-person sound communications.

The human interface management unit 1802 stores node-to-person sound communication rules, and stores diverse alarm sound and voice announcement that can be recognized by a person. The node-to-person sound communication rules include procedures of recognizing a command that a person speaks, processing the command, and outputting the command recognizable by a person as a synthetic voice. Specifically, unlike the existing sound recognition method, the frequency pattern of the command spoken by a person is arranged and stored in a table, it is judged whether the voice spoken by the person corresponds to a specified command pattern stored in the table, and if the voice corresponds to the specified command pattern, the corresponding voice is recognized as the specified command. According to this method, a specified command spoken by a person can simply recognized using the same principle as the basic method of sound communications. By contrast, a node records in advance a specified letter of advice, and then transfers the recorded information to a person.

Of course, it is also possible that a node that has a built-in voice recognition chip recognizes sound spoken by a person to respond to a specified command, or combines sounds to transfer the combined sound to a person.

On the other hand, if the node receives the person's command through the person-to-node sound communications, it processes the command and transfers the processed command to another node in the network, so that the other node can respond to the person's command. That is, the sound communication protocol storage unit 1803 has a sound communication protocol stack stored therein. The address management unit 1805 stores and manages not only the address of the node itself but also the addresses/IDs of the devices connected to the network, shortcut addresses, routing table, and so forth.

The conversion processing unit 1804 judges whether to perform node-to-node sound communications or node-to-person sound communications, and performs the node-to-node sound communications and node-to-person sound communications in cooperation with the sound communication unit 1801. During the transmission, the conversion processing unit 1804 selectively performs the node-to-node sound communications and the node-to-person sound communications according to the application's requirement and the surrounding environment. For example, if an emergency situation that requires an alarm sound is produced, the conversion processing unit informs the surrounding nodes of the emergency situation through the node-to-node sound communication, and outputs an alarm sound to persons around the node device. During the reception, the conversion processing unit decodes the sound received from another node device and extracts data, or decodes sound, such as voice or vocal sound, received from the persons around the node device, and recognizes the person's intention.

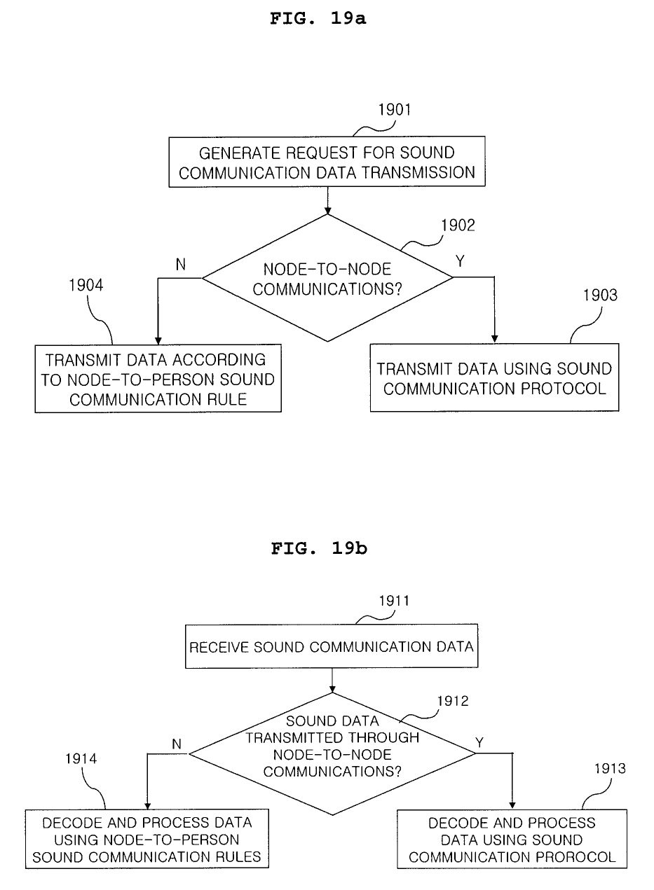

FIGS. 19A and 19B are flowcharts illustrating human sound interface function of a sound communication node device during transmission and reception. FIG. 19A shows the human sound interface function performed during the transmission, and FIG. 19B shows the human sound interface function performed during the reception.

Referring to FIG. 19A, at step 1901, the node device generates a request for data transmission through sound communications. At step 1902, it is judged whether to transmit the corresponding data through the node-to-node sound communication or the node-to-person sound communications. If the node-to-node sound communications are selected as a result of judgment, the data is transmitted to a specified node through the sound communications at step 1903. If the node-to-person sound communications are selected, an alarm sound or synthetic voice is transmitted to the persons around the node device according to the node-to-person sound communication rules.

In the case of the reception, as shown in FIG. 19B, the sound from the sound communication unit is received (step 1911), and it is judged whether the received sound is the sound data transmitted through the node-to-node sound communication protocol (step 1912). If the received sound is the sound transmitted through the node-to-node sound communication protocol, the data is decoded and processed using the protocol (step 1913). If the received sound is not the sound transmitted through the node-to-node sound communication protocol, the data is decoded according to the node-to-person sound communication rules, and the person's intention is recognized and processed. On the other hand, if the received sound is not significant sound transmitted from another node or a person around the node, but is noise, the process proceeds to step 1914, and the received sound is disregarded without being analyzed as the significant command.

As described above, according to the present invention, a user can construct a PAN around the user through software download using almost all portable terminals being currently commercialized, without the necessity of replacing the portable terminal or adding any separate transmission device.

Also, according to the present invention, node devices of the PAN can compatibly and efficiently construct a local area communication network with other node devices or user portable terminals in the PAN.

Also, according to the present invention, the sound communication network can be used as an alternative means when telecommunication interference, obstacle, or trouble occurs.

Also, according to the present invention, a PAN node device having two or more local area communication means can communicate with other different local area communication means in accordance with the required transmission speed or power consumption.

Also, according to the present invention, a PAN node device having a convenient human interface with a person can be implemented.

Also, according to the present invention, the portable terminal which can serve as a PAN node can be miniaturized at a low cost since the sound communications do not require additional internal space, although the local area electric communication means such as Bluetooth and ZigBee is not the essential element of the portable terminal and thus requires additional space in the portable terminal.

Also, according to the present invention, since the sound communications do not cause the electromagnetic emission, the local area network using the sound communications is advantageous to health care in comparison to the electric communication network.

Also, according to the communication procedure according to the present invention, the communication efficiency, such as interference or hacking prevention, error rate reduction, and so forth, can be improved, and thus the actual use of the sound communications can be sought.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A local area communication network, comprising:
a personal area network (PAN) coordinator capable of performing sound and electric communications and controlling a communication flow in the network; and
at least one end device connected to the PAN coordinator through a sound and/or electric communication channel;
wherein the PAN coordinator includes a conversion means for performing mutual conversion between a sound communication protocol and an electric communication protocol, and is able to be connected to another external communication network.

2. The local area communication network of claim 1, further comprising a PAN router relaying communications between the PAN coordinator and the end device.

3. The local area communication network of claim 2, wherein the PAN router receives an instruction of the PAN router, and manages the communication flow of the at least one end device.

4. The local area communication network of claim 2, wherein the PAN router comprises a conversion means for performing mutual conversion between the sound communication protocol and the electric communication protocol.

5. The local area communication network of claim 1 or 4, wherein the conversion means comprises a sound communication unit, a sound communication protocol storage unit, an electric communication unit, an electric communication protocol storage unit, an address management unit, and a conversion processing unit;
wherein the address management unit includes addresses and IDs of node devices in the network, a routing table, and protocol information for enabling the respective devices in the network to perform communications; and
wherein the conversion processing unit decides whether to perform self-process or relay process of requested data, judges whether conversion is required by grasping the protocol information of a source device and a destination device in the case of the relay process, performs data and packet conversion with reference to the sound communication protocol storage unit and the electric communication protocol storage unit in the case where the conversion is required, and controls communication flow of the sound communication unit and the electric communication unit.

6. The local area communication network of claim 5, wherein the address management unit periodically or intermittently stores/manages status values of the devices in the network.

7. The local area communication network of claim 6, wherein if the PAN coordinator receives a communication request for a device managed by the PAN coordinator itself from an external network, it transfers the status value of the destination device stored in the address management unit of the PAN coordinator to the external network.

8. The local area communication network of claim 5, wherein the address management unit includes shortcut addresses, and the shortcut address includes an internal shortcut address for designating a node in the network and an external shortcut address for designating a node that belongs to the external network.

9. The local area communication network of claim 1, wherein the PAN coordinator simultaneously or selectively sets a sound communication path and an electric communication path with a device located in the network and capable of performing both electric and sound communications.

10. The local area communication network of claim 9, wherein the PAN coordinator is set to select the sound communications or the electric communications in accordance with the characteristic of transmitted data.

11. The local area communication network of claim 1, wherein the PAN coordinator and the end device further comprise a voice recognition unit and a data conversion and packet generation unit;
wherein the data conversion and packet generation unit converts voice data of a user recognized by the voice recognition unit into packet data for transmission, and converts packet data transmitted from another device into voice data.

12. A local area communication networking method using sound communications, comprising:
selecting a PAN coordinator by a user's setting in advance or negotiation among respective participating devices;
determining a sound communication level in consideration of a surrounding environment, the characteristic of an application, and performances of the participating devices;
generating coding rules including mapping table generation information in accordance with the determined sound communication level;
generating the mapping table in accordance with the coding rules; and
performing communications in a network by performing a mutual conversion between binary data and sound based on the mapping table.

13. The method of claim 12, further comprising:
generating mapping table alteration information and transmitting the alteration information to the participating devices;
periodically or conditionally altering the mapping table based on alteration information; and
performing communications in the network on the basis of the altered mapping table.

14. The method of claim 12, wherein the step of selecting the PAN coordinator comprises:
a participating device announcing that it is the PAN coordinator to other devices; and
selecting the node which has first announced that it is the PAN coordinator as the PAN coordinator if a plurality of devices have announced that they are the PAN coordinator.

15. The method of claim 12, wherein the step of determining the sound communication level and the step of generating the coding rules are performed by the PAN coordinator.

16. The method of claim 12, further comprising:
requesting its participation to the PAN coordinator by the device that intends to participate the network;
approving this and transmitting the coding rules by the PAN coordinator; and
performing the communications according to the coding rules by the newly participating device.

17. The method of claim 12, wherein the step of performing the communications in the network comprises:
giving a shortcut address that is shorter than an public address for each device; and
designating a specified device in the network as a destination using the shortcut address.

18. The method of claim 12, further comprising communicating with an external network through the PAN coordinator.

19. The method of claim 18, wherein the step of communicating with the external network comprises:
generating a shortcut address of a specified node in the external network when communications with the specified node is first performed; and
designating the destination using the shortcut address in the following communications with respect to the corresponding specified node.
